(19) United States
(12) Patent Application Publication
(10) Pub. No.: US 2019/0241079 A1
(43) Pub. Date: Aug. 8, 2019

(54) System with means and methods for an autonomous vehicle module and modules combination in a velocity controlled nonstop operation with schedule stops

(71) Applicant: Shu Ya Huo, San Francisco, CA (US)

(72) Inventor: Shu Ya Huo, San Francisco, CA (US)

(21) Appl. No.: 15/932,086

(22) Filed: Feb. 2, 2018

(51) Int. Cl. B60L 15/38; G05D 1/00; B25J 15/00; B60L 13/04; B61K 1/00; G08G 1/123; B61D 13/02; B60L 5/18; B60L 8/00; B60L 11/00; B61C 3/02

(52) U.S. Cl. CPC B60L 15/38; G05D 1/0088; G05D 1/0022; B25J 15/00; B60L 13/04; B61K 1/00; B60L 2200/26; B61D 13/02; B60L 5/18; B60L 8/003; B60L 11/002; B61C 3/02; G08G 1/123

(57) ABSTRACT

The objective of this invention is to provide a solution that will enable an autonomous vehicle module and module combination formation-deformation and its transportation in various modes, more particularly, it relates to a system with means and methods that control such operation in one of the defined moving transportation mode, with central computer controlled network, wired and wireless, to implement a scheduled multi-stop nonstop operation for passengers and cargo delivery at a controlled velocity through a head-vehicle-module (HVM) and end-vehicle-module (EVM) rotating in turn to accelerate the HVM from each stop to couple with the moving catching-on master-vehicle-module (MVM) at its speed in the front of it, and decelerate the EVM to a stop at each passing-by stop from the end of the MVM, to load and upload passengers and cargo.

### FIELD OF THE INVENTION

The field of this invention relates to an autonomous vehicle module and modules combination formation-deformation and its transportation in various modes, more particularly, it relates to a system with means and methods that control such operation in one of the defined moving transportation mode, with central computer controlled network, wired and wireless, to implement a scheduled multiple-stop nonstop operation for passengers and cargoes delivery at a controlled velocity through a head-vehicle-module (HVM) and an end-vehicle-module (EVM) rotating in turn launching and accelerating the HVM from each stop to couple with the moving master-vehicle-module (MVM) at its speed in the front of it, and decoupling and decelerating the EVM to a stop at each passing-by stop from the end of the MVM, and to load and upload passengers and cargoes.

### BACKGROUND OF THE INVENTION

U.S. Pat. Nos. 4,425,851, 797,168 and 4,065,006 described train systems and their operations; U.S. Pat. No. 8,774,992 described a train control system. Although these patents relate to load and unload passengers and cargoes without stopping the moving train, and their controlling systems, the purpose of those systems are all for doing loading and unloading from an outside moving carriers, which by itself can not be an independent operation system, and transfer passengers and cargoes in motion without stop to and from the moving train, also the control means are mainly on-board based, while they all never touch the subject matter of loading and unloading passenger and cargoes from and to a stopped still vehicle that is a module and part of a master vehicle modules system which by the module itself can be a standalone autonomous transport vehicle, and the control of such operation is on-board and off-board central controlled via a wire-wireless network; also, non of those patents are self-driven module based components that can form combination of vehicle modules. Mr. Chen Jianjun's design published on the web and Youtube is a high-speed train top rail guided and carried carrier to transfer passengers to/off a running high speed (HS) train without stopping at station. The problem for it is having a heavy impact to passengers from the staying still to dropping off the transfer-passenger-carrier onto the top of the HS-train fast running at 200-350 km/hour passing through the station, unless either the HS train slow down to near-stop to land the carrier onto the train, or the carrier has a driven system to move it at speed up to the same as the HS train, then to drop it onto the train, that would require the carrier has the same power and driven system as a HS train; plus, all the above prior arts require a large top space which it is in conflict with current clearance height of HS-train of about 3.8 to 4.4 meters, and must modify the current tunnel and top electricity power structure, also they increase air-resistance when add a top section for HS-train. While the side passenger and cargo transfer train solution requiring occupy large extra operation area at each station, and matching operation and equipment, which are all increasing the overall cost. U.S. Pat. Nos. 8,239,080 and 8,612,071 described a subway express line and local line interchange and transfer methods for passenger more efficient transport to save time, while it is different from this invention methods which are more efficient up to multiply time saving, passenger volume and revenue earning. At the time of this filing, there is not yet a passenger and cargo load and unload system for nonstop vehicle modules with stopping operation that is cost effective, efficient and useful as this invention provides.

Currently, trains and buses, low to HS, are all operated on a scheduled-stop-at-station mode. To speed up operation, trains and buses are operated in various classification, such as regular-express that by-pass small stations of regular traffic location or small cities, express line that by-pass medium traffic location or medium size city stations, and ultra-express that only stop at major stations with lots of on/off volume, such as major intersection location or big city stations; also there is designed purposely graded express route, and more recently build graded HS-train that operate at speed above 200 km/hour. In a metro setting, city mass transportation also provide ways to handle high traffic in the peak time by providing more frequency of trains and express routes and tracks which also by-passing small and/or medium stations to increase capacity and speed. Yet, frequency has limit, the highest frequency seen in between the train is 1.45 minutes occasionally used by the world top ridership operation—Beijing Subway, that still require stop times, 370 stops each have 45 s or 0.75 minute stop time at each one, is about 4.63 hours, peak hour 3 or 180 minutes total, if divided by 0.75 minute per stop, is 240, 240 times 4.63 hours is 1111 hours total peak our stations time for all trains in a morning shift; if add acceleration and deceleration time 1 minute/stop, would be more than double the time of 2222 hours, a speed express line will first solve the problem to some extend for time conscious people like Tokyo, New York city and London. Yet, all express lines, in a metro mass transit or in a HS-train setting still need to stop at major stations. Speed produces the side effect of reduced passengers and cargo, due to bypassing stations, which means reduced revenue. So the current problem of scheduled transportation for passengers and cargoes are wasted time and lost passengers and the current solution to it is either unpractical or uneconomic.

### SUMMARY OF THE INVENTION

The objective of this invention is to provide a solution that will enable an autonomous vehicle module and modules combination formation-deformation and its transportation in various modes, more particularly, it relates to a system with means and methods that control such operation in one of the defined moving transportation mode, with central computer controlled network, wired and wireless, to implement a scheduled multiple-stop nonstop operation for passengers and cargo delivery at a controlled velocity through a head-vehicle-module (HVM) and an end-vehicle-module (EVM) rotating accelerate the HVM from each stop to couple with the moving master-vehicle-module (MVM) at its speed in the front of it, and decouple and decelerate the EVM to a stop at each passing-by stop from the end of the MVM, and to load and upload passengers and cargoes.

In one preferred embodiment of the invention, it is implemented in a train operating under 200 km/hour (medium to low speed), where the MVM is composed of 1 to N member units of self-driving-autonomous-module units, including HVM in the front and EVM in the end (EVM and HVM each can include 1-m units) and the MVM units in the middle (including 1 to (N-m) units). When the train leave the start terminal, the central control operation remotely start to control the operation by sensing its most economic operating cruise speed (Ve), by using data from sources, such as the satellite position system, of the start station D(i)(i=0, to n) satellite position data P(xi,yi) and the next station D(n)(n=i+1) satellite position data for the distance Drl(n)=D(n)−D(v) of the moving modules (D(v) is the distance to the start station of the moving modules, Drl is the distance of control-release of EVM and control-launch of HVM to the next station(n) ahead) to the station ahead scheduled to stop. At the distance when it is idea by past pattern to accelerate at most economic rate (Ae) for the HVM to meet the MVM, the control center shall issue instruction to 1) authenticate the front station HVM and upon all operating data is verified ready for departure (including its ID, passenger/cargo boarding/upload status, door lock status), 2) check the passenger/cargo on/off board/unloading request for releasing the EVM for passenger/cargo off/unloading readiness, 3) set the acceleration and deceleration rate for the HVM and EVM, 4) upon readiness of HVM and EVM, instruct the on-board control mean to instruct its power-motor device to start moving the HVM at the set acceleration rate to catch and meet the MVM at the end of it, and release the EVM by instructing the decoupling device to separate it from MVM and the brake to decelerate at set rate for the EVM to stop at the up coming station, 5) upon sensing the meet-touching of MVM and HVM by electric-mechanical sensor, couple the two together by an automatic connect-fixing and locker system, and release the through-door locker for passenger passing through, in the mean time the EVM upon sensing the entering of the station zone by the moving modules satellite position data and/or electric-mechanical sensor, instruct brake to stop the EVM at stop line, which activate the EVM side door open automatically for passenger off/on, cargo unloading/loading. 6) repeat 1)-5) for the coming n+1 stations until the end terminal station where there will be no HVM detected, and will be no releasing the EVM, and 7) via a track/line switching procedure, the HVM-MVM-EVM will run continuously for a return shift, following the same operation process.

For SF-LA, 200 km/hour train, 2 hour 40 minutes travel time for 530 kms, if 18 stations in between SF-LA, will be average 30 km between stations. For nonstop operation, it will take 2.40 hours, by-pass the 18 stations, and if the train stop at 3 main stations, or at 18 stations without HVM and EVM, would need 3.40 hours for the trip, or 8 hour 40 minutes for the trip. With HVM, EVM and operation stop at above stations without stop the MVM, could save 39% time with possible more than 50% revenue loss, or could have 331% time saving with possible more than 50% revenue earned due to more station stops for more passengers, yet nonstop MVM.

The Amtrak Boston-NY-DC Acela Express need 7 hours 42 minutes to travel for the 394 miles (634 kms). If train run at 200 km/h (fare site data) nonstop, it needs 3.17 hours. It needs 7.7 hours if stop at the scheduled 16 stations. 7.7-3.17=4.53 hours consumed by those stops, or average 17 minutes/stop, including stop stay times and deceleration and acceleration time consumed per stop. If average 7 minutes for passengers on-off/station, 10 minutes for acceleration and deceleration. Total time saved if run HVM/EVM/MVM mode, would be 4.53 hours. Actually, there are more small stations by-passed by the Acela Express. If all those stops included, will add more revenues due more passengers on/off at those additional stations' stops, yet still save time at 3.17 hours.

Coast Starlight Seattle-LA, 28 stops, 34 hour 44 minutes, 1377 miles (2216 kms), run at 79 mph (127 km/h) top speed. If use average speed at 50 mph (80 km/h), it use 2216/80=27.77 hour for the trip. 34.73-27.77=6.98 hours, 6.98/28=25 min/stop. If run EVM/HVM/MVM mode, about 7 hours would be saved per trip.

Another operation embodiment of this invention is used for Maglev train, especially the low-medium speed maglev train under 200 km. The operation control mean and method similar to the above embodiment, except the motor and brake control system are adapted to the maglev train structure and components.

China ChangSha Maglev train operate on a route with 5 stops, run through time is 19.30 minutes at 80 km/hour for 19.8 km long with 3 stops in between. That means it takes 15 minutes run-through with 4.18 minutes for stops and acceleration/deceleration (Maglev has better energy saving, faster acceleration and low noise low maintenance, etc. advantages). If nonstop run the operation will save 4.18 minutes each run. It operate 16 hours/day with average 12 minutes in between each run, there will be 80 run each way per day. It will save 160×4.18=668 minutes/day or 11.12 hours/day, or 162 days per year time saved.

If San Francisco Bart use Maglev to operate for its 175 kms operation with 46 stations, average 3.8 kms between stations. If nonstop operate, each station peak time stay 0.3-1 minute/stop, average 0.45 min/stop, average 5 minutes headway between runs. If operate at speed 80 km/hour, peak time 3 hours, 180/5=36 times stopping/station, 36*46=1656 time stops, total time saved for stops=1656 stops*0.45 min/stop=12.42 hrs and if 2 min for acceleration and deceleration per stops, nonstop run passing the acceleration and deceleration distance is 0.3 min/stop, total time saved would be 12.42+1656*(2-0.3)=59.34 h peak hours/day, or 764 days per year, if plus 3 hours peak time of evening, will be 1528 days/year saved. The raised average speed of 24 km/hour also add saving.

Another embodiment of the invention is for the HS-Train running above 200 km/hour up to 500 km/hour. In this case, the HVM and EVM front and back will be structured to make it air-streamlined in shape, like the bullet train spike type head and end. This require the HVM head should be made auto shape change to make the head in an spiking type air streamline structure, that is composed of electric-mechanical-powered light strong flexible material to extend out to form a sealed bullet or semi bullet head shape when it become HVM and withdraw back to the upper and side of the HVM to become part of MVM when it become the new head of MVM and end of HVM, same to the EVM.

Another embodiment of the invention is for the metro mass transit system, that usually has to handle crowded passengers during the peak time, where the design for the HVM/MVM/EVM will be a maximum clearance in height and width of the vehicles, to allow the internal structure accommodating a blocking-free-pass-through path for the near-off passengers moving from head to the end, also allow the least interference between long distance passengers and near-off passengers. One option could be double deck that make the stay-passengers go to the top/bottom and near-off passengers in the lower/upper part, with option to make the upper or lower deck section relative fixed to the movable lower or upper section. Another design is to make the free-pass-through path located in the upper-middle section, or upper-side section. The idea is to allow the EVM direction moving near-off passengers free of blocking, jamming and interference during the crowded peak time.

In the case of very condensed stop to stop distance, such as New York Subway, with an average between stop distance of only about 0.8 km or 0.5 miles, it is not suitable direct use the above mentioned use for this invention, unless there is enough distance, such as >4 kms or 2.5 miles between stops for the most economic operation, this can be solved by skipping stops in between, which is another embodiment of the invention's vehicle module operation system, where the modules of HVM111-MVM11-EVM111 is operated nonstop for some skipped stops in between the EVM drop-stop, and HVM launch-ahead (at every stop station regularly) mode, such as every 2-6 stops skipped, and with rotating drop-stopped EVM(11n), where n is the number of non-skipped stops) self-driving to the next farthest skipped stop ahead before the next non-skipped stop, which is where the next HVM(n=i+1)'s one stop earlier Station skipped, so the next shift HVM121-MVM12-EVM121 shall launch the HVM121=EVM11 at station(n=i+1)'s one stop earlier the skipped station(n−s) [(n−s)=s−1, s is the station series number]. This one stop shifting one after another will allow rotating pick-up and drop-off passengers of all the skipped stations in turn by a serious scheduled new shift runs of HVM(kjn)−MVM(kj)−EVM(kjn), where, if n is the non-skipped stop station numbers, j is the shift numbers, and if maximal 3 skipped stops in between station(n−s) and station(n−(s+4)), HVM-MVM-EVM shall have j+1 time runs to cover the skipped stops between non-skipped stations, and then, start a new round of k+1, where k is circle number of a round, started by running a head modules series of 5 HVMs as it is at the very beginning, to drop each HVM211, to HVM215 for each Express non-skipped stations to pick up and drop off passengers, and that operate at a between run headway time intervals for new round of rotation shift runs. The headway interval between shifts is longer than previously non-express peak regular operation that has all station stopped, yet, has much more efficiency with possible more than double time saving, and have all the stops covered with express operation nonstop.

The option of making the upper section of each module relative fixed to the bottom section can make stay passengers going to the top without bothering interfering with the bottom near-off backward moving passengers. Between the top section and lower section, there is a moving mechanism build into the bottom of top section and the top of lower section, that are activated to move by signals for bottom HVM launching to move ahead and bottom EVM releasing behind to stop, by which, the bottom MVM shall follow the leaving bottom EVM moving backward to fill the empty lower section and give out the same module space in front of the MVM which will holding the incoming bottom section of HVM. This upper and lower (top and bottom) modules shifting movement is conducted by the signal command instructing the electric-mechanical system in the upper and lower section of the MVM to 1) close and lock the doors in between and on each side of upper and lower modules, and the through doors in between and on each side of the lower EVM and MVM, and HVM and MVM, 2) lower a pair of roller-gears from the bottom of top MVM and 3) gear-in the pair of roller-gears from upper MVM (including upper HVM, MVM and EVM, but no unit moving away) with the rail guide teeth at the lower modules of HVM, MVM and EVM, 4) motors from the top modules drive the roller-gear to move the upper MVM and lower HVM, MVM and EVM toward the opposite direction: the lower HVM, MVM and EVM move backward toward the empty EVM position in the end, and the upper MVM move forward to give the same EVM space underneath it in the front, and 5) upon the lower MVM moving into the former EVM position, the lower end unit of MVM become new EVM, lock with the upper MVM, and 6) gear-off the rail guides with the roller-gears and move the roller-gears back to their original positions 7) in the mean time to have the incoming lower HVM guided moving into the giving empty space under the MVM, and 8) lock the lower and upper modules together automatically at the lower HVM filled position 9) open and unlock the doors in between and on each side the the upper and lower modules, and the through doors in between and on each side of EVM and HVM, and HVM and MVM, and. The 1)-9) steps shall repeat at each passing-by station in turn till to the end station where no HVM in the front, so there is no EVM release. Rail guiding gear coupled with a rolling gear to move the module is only one choice for the moving-shifting mechanism, there are many existing electric-mechanical mechanisms that can do the work and are choices of this part of the invention component to use.

This rotating shifting operation of HVM to MVM to EVM with flexibility of adding and reducing modules in transit to reach an ever high capacity to handle the extreme of high traffic volume in mega metro mass transit situation, where the EVM can be a whole chain of 8-10 large cars combination, while the staying passengers on MVM is separated from the EVM, that leave a whole 8-10 cars empty train at every station for passengers to get in, a 100% capacity instead at least <50% than before in a high traffic rout, which was impossible before when the 8-10 cars train was full of people heading to a city center destination, causing crowded packing of people in the car. This will handle at least double amount of traffic in peak time than the current most jammed station. Passenger transportation volume is measured not only by the full capacity of a train, but by its per station passenger on/off turnover volume. If only the 2 ends terminal has the most people packed the train, with little space left over for in between stations, even it is high capacity contained, it still not a high turnover volume by station. This invention will allow both high capacity and high turnover, that is not available by the current transport mean and method.

Another embodiment of the invention is to use self-sustaining clean power system, such as solar power collection panel, surface coating film/material on the outer surface of the vehicle modules and on the graded or non-graded track and/or road right-of-way area, and solar power storage and electricity generating devices; also can use micro-nuclear power generator on the vehicle module.

The HVM-MVM-EVM modules operation could also has emergency islands to clear the route for straight run through situation, such as hazard or medical emergency, where the stopped HVMs and EVMs will move to a side track or side parking place at the station to give away the route for HVM-MVM-EVM pass-through free of blocking.

The objective and characteristics of the invention will become apparent from the following drawings and the detailed description.

### BRIEF DESCRIPTION OF THE DRAWINGS

FIG. 1 is the overall in operation chart of the HVM-MVM-EVM units covering elements 101, 102 . . . to 114.

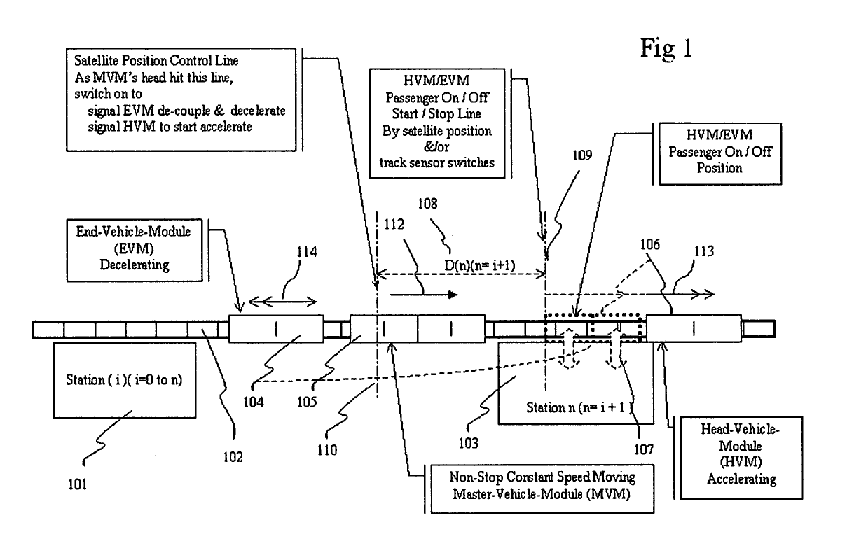

FIG. 2 is the overall block diagram of components of the HVM-MVM-EVM, covering elements 201, 202, . . . to 214.

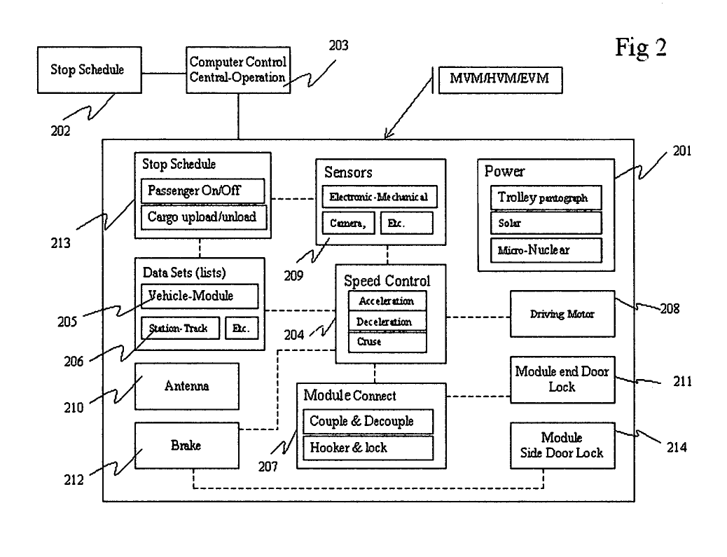

FIG. 3 is the process block diagram of the control of and work-flow process of the operation, covering elements 301, 302, . . . to 317.

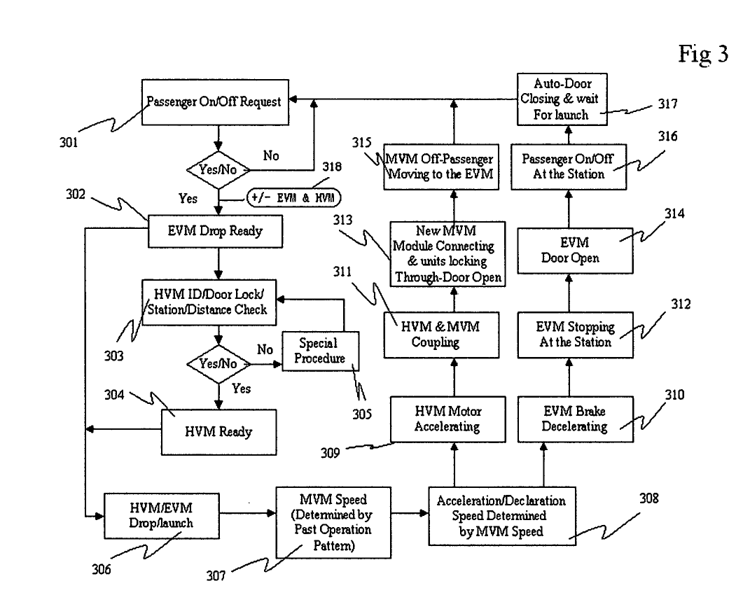

FIG. 4 is the diagram of one of the embodiment of the off-passenger pass-through path, covering elements 401, 402, . . . to 407.

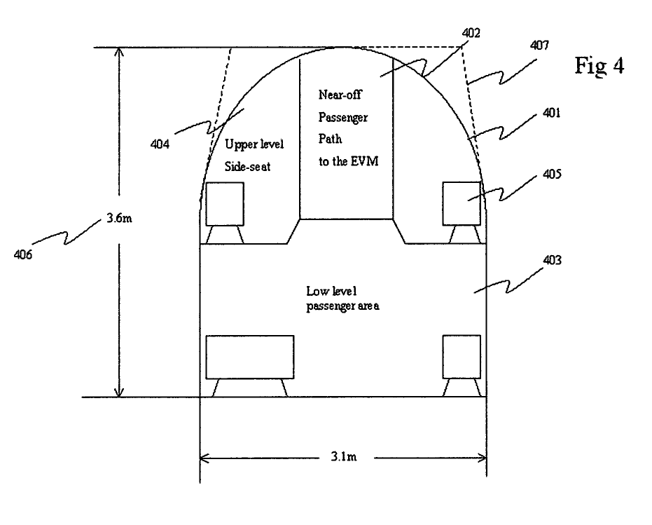

FIG. 5 is the one of the vehicle cross-section diagram for the module, covering elements 501, 502, . . . to 514.

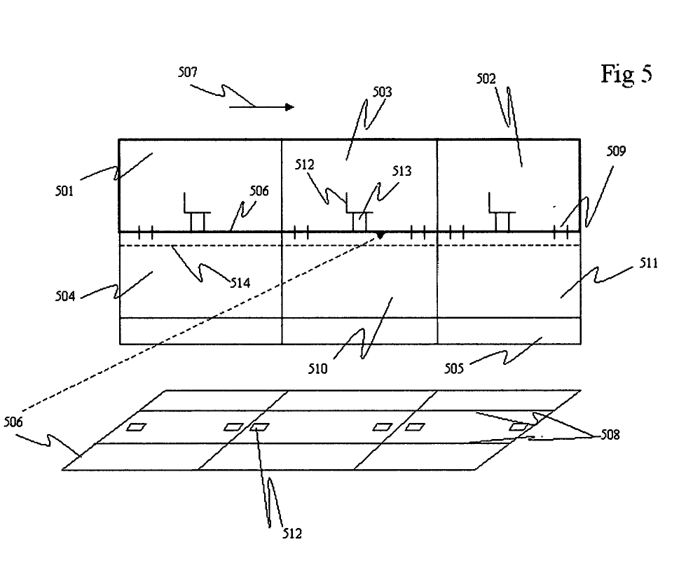

FIG. 6 is the diagram of a double deck vehicle module combination with a movable bottom section, covering elements 601, 602, . . . to 611.

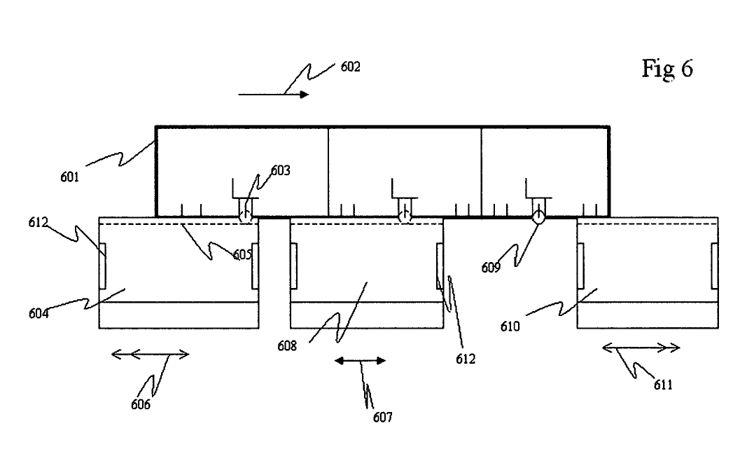

FIG. 7 is the flowchart of the working process of the double deck vehicle module combination, covering elements 701, 702, . . . to 711

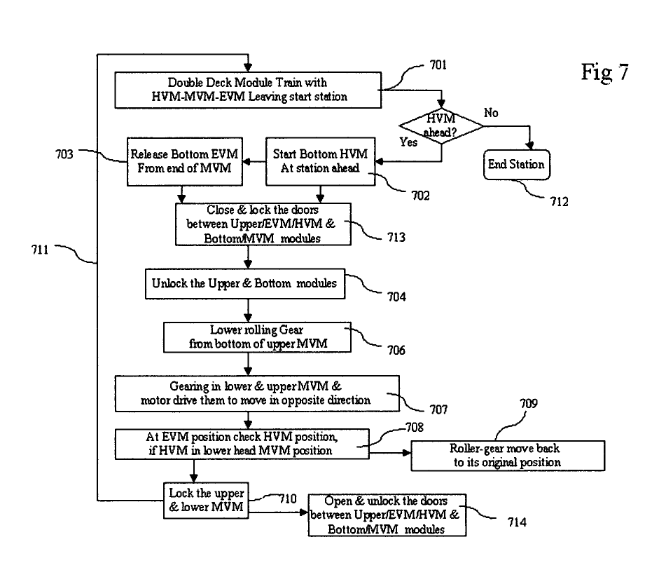

FIG. 8 is the diagram of working process of a rotating Express run of the vehicle modules on a multiple skipped stops with multi-1^{st}-round stopping stations, covering 801, 802, . . . to 816.

FIG. 9 is the diagram of the head-cover for high speed operation mode, covering 901, 902, . . . to 904.

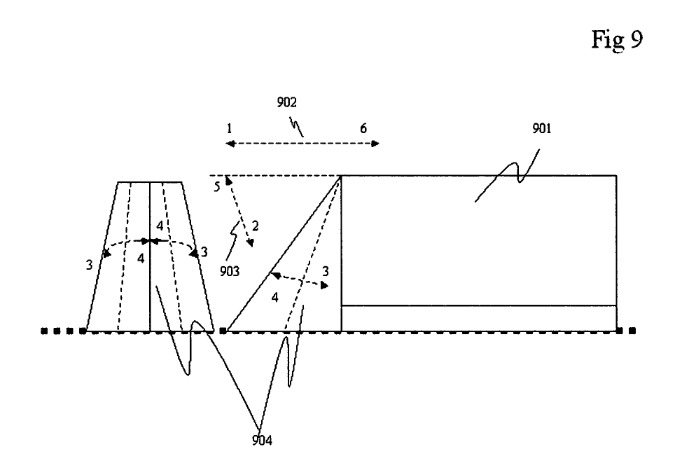

FIG. 10 is the diagram for a side island of emergency parking and a optional wheeler structure for holding multiple module vehicle for emergency and for capacity adjustment, covering 1001, 1002, . . . 1005.

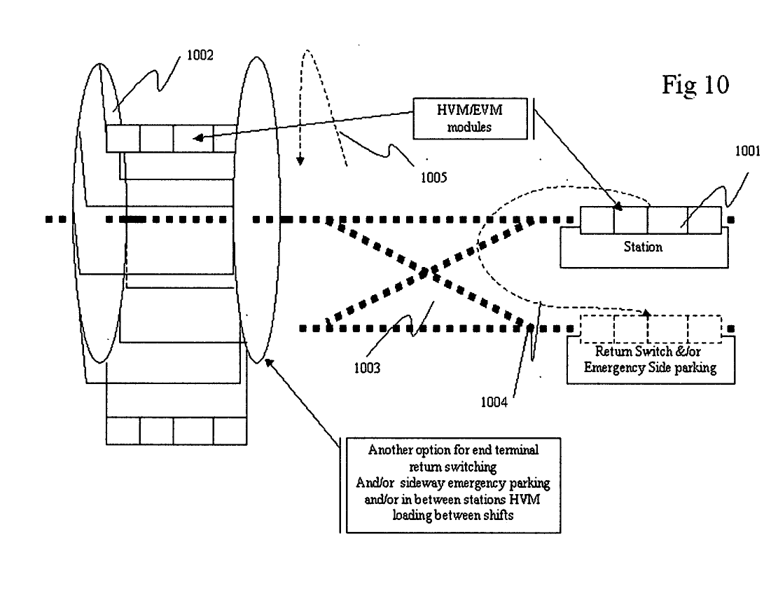

FIG. 11 is the diagram showing the high capacity operation of the vehicle modules, covering 1101, 1102, . . . 1106.

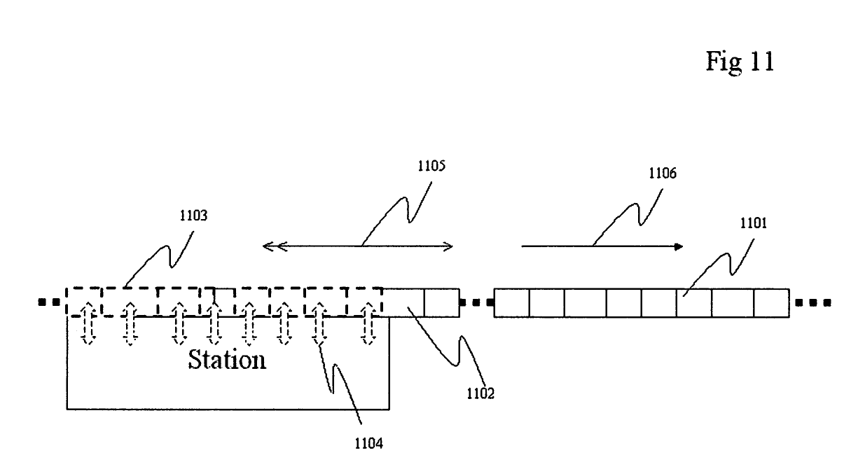

### DETAILED DESCRIPTION

In one preferred embodiment of the invention, it is implemented in a train modules operating under 200 km/hour (medium to low speed), where the MVM 105 is composed of 1 to N unit of self-driving-autonomous-modules units, including HVM 106 in the front and EVM 104 in the end (HVM and EVM module unit m>1 for each) and the MVM 105 units in the middle (include 1 to N−m(HVM+EVM) units). When the train leave the start terminal station 101, the central control operation 203 remotely start to control the operation by sensing its economic operating speed (Ve) 112 and its station D(i) (i=0−n) to station D(n) (n=i+1) distance 108 from the front station scheduled for picking up passengers and/or cargoes, and the distance of the moving modules from the start terminal, all measured by their corresponding satellite position D(xi,yi). At the distance Drl=D(n)−D(v) when it is idea by past pattern to accelerate at most economic rate for the HVM 105 to meet the MVM 105, the control center 203 shall issue instruction to 1) authenticate the HVM 106 at front station 103 and upon all operating data is verified ready for departure (including its ID 206, passenger/cargo boarding/upload status by door lock status 214, etc.), 2) check the passenger/cargo on/off board/unloading request 301 for releasing the EVM 104 for passenger/cargo off/unloading readiness 302 and 303, 3) set the acceleration and deceleration rate 308 for the HVM 106 and EVM 104, 4) upon readiness 304 of HVM 106 and EVM 104, instruct the on-board control mean 204 to instruct its power-motor device 208 to launch 306 the HVM 106 at the set acceleration rate 113, 308 to catch and meet 309 the MVM 105 at the end of it, and release 306 the EVM 104 by instructing the decoupling device 207 to separate it from MVM 205 and the brake 212 to decelerate at set rate 114, 308 for the EVM 104 to stop 319 at the up coming station 103, 5) upon sensing the meet-touching of MVM 105 and HVM 106 by electric-mechanical sensor 209, couple 311 the two together by an automatic connect-coupling and locker 207 system, and release 314 the through-door locker 211 for passengers passing through 316, in the mean time the EVM 104 upon sensing the entering of the station zone 109 by electric-mechanical sensor 209, instruct brake 212 to stop 312 the EVM 104 at stop line 109, which activate the EVM 104 side door lock 214 to open 314 automatically for passengers off/on 107, cargoes unloading/loading 316. 6) repeat 1)-5) for the coming n stations 102 until the end terminal station 711 where there will be no HVM 106 detected, and will be no releasing of the EVM 194, and 7) via a track/line switching procedure, the MVM will run continuously for a return shift, following the same operation process.

The embodiment of Amtrak Washington D.C.-New York City-Boston Acela Express HS-train can implement this invention by using the HVM-MVM-EVM benefits optimized operation. Acela Express need 7 hours 42 minutes to travel the 394 miles (634 kms). Assuming it runs at most economic speed (Ve) at 200 km/h nonstop for the whole trip time of 3.17 hours and stop at 16 stations at most economic time (Te) of an average 17 minutes/stop, including per stop staying times 8 minutes and deceleration and acceleration time of 9 minutes consumed per stop, assuming 5 minutes used for acceleration (Ae) and 4 minutes for deceleration (Be). By this invention, assuming the

D(i)(i=0, to n)=satellite position data P(xi,yi) and/or track sensor switch location data for station(0),

D(n)(n=i+1)=satellite position data and/or track sensor switch location data of station (n)(n=i+1, if i=1) to station(n)(n=i+1, if i=0)

D(v)(v=i+1)=satellite position data and/or track sensor switch location data of the moving modules to station (n) (n=i+1, if i=1)

Drl(n)=D(n)−D(v)=the controlled release EVM and launch HVM distance to the next station (n) ahead

Ta(n)=Time needed to most economically accelerate HVM(n),

Ve=most economic cruise speed by past operation pattern,

Ae(n)=most economic acceleration speed by past operation from stops by past operation pattern on the route.

De(n)=most economic distance to accelerate 114 and/or decelerate 113 at a station(n) 103 on the route by past operation pattern, ideal when

Drl(n)=De(n)=D(n)−D(v),

A(n)=Accelerating 309 speed needed to run HVM(n) 106 to meet the MVM 105 Ta(n)=De(n)/Ve, A(n)=Ve/Ta(n);

Ta\hat{ }d=acceleration and deceleration time

Tstp=station stop time

Upon passenger 107 request 301, the central control operation 203 shall get De(n) 108 and Ve from station table 205 and module table 206 and calculate A(n) 113, Te(n). Upon HVM(n) 106 detected 302 & verified 303 operation data from those tables 205 and 206 for Station(n) 103 ahead, get the 307, 308:
Drl(n)=D(n)−D(v), calculated by satellite position data and/or track sensor switch location data from the station(n) and vehicle module's table lists' data-sets, when
Drl(n)=De(n), launch acceleration at Ae, and if the
Ve=200 km/h, Te(n)=De(n)/Ve, if
Drl(n)>60% De(n), A(n)=Ve/Te(n). Require all
Drl(n) must >60% De(n), otherwise, not economical and practical For Acela, Ve=200 km/h=200000 m/3600s=55.56 m/s, Te(n)=5 min=300 s,
De(n)=(Ve−0)/2*(Te(n)−Tstp−Ta\hat{ }d/2)=55.56/2*300=8334 m=8.33 km, for deceleration, use 6 km, total acceleration and deceleration use 14 km, passing through 14 km distance at Ve takes Tp (pass through time at Ve)
Tp=14/200=0.07 hr=4.2 minutes=252 s, this is the time needed to accelerate the HVM(1) (if i=0, n=i+1=1) to meet the MVM, that require
A(1)=55.56/252=0.22 mpss=0.7 fpss, faster acceleration consume more power and more equipment worn. If by past operation optimization, 14 km/2 is the De, 17 minutes/stop time for stopping is the Te, the best A(1) should be between De and Ve/Tp, that is A(1) between 0.22/2 mpss to 0.22 mpss. The control line of entering the release-drop/start-launch zone, should be at a Drl(1)=(Ve−Vo)/2*(Te(1)−Tstp−Ta\hat{ }d/2), and if it is <60% of De/2, that make it uneconomic.

Continue to instruct the HVM(1) 106 in wireless to accelerate 309 to meet the MVM 105, upon meeting the MVM 105, activate the hooking mean 207, to couple the HVM(1) 106's end with the MVM 105's head. A synchronized decoupling/dropping 306 of the EVM(1) 104 from the MVM is done in the time when the MVM 105 arriving the control line 110, from which the Drl(1) is reached when the dropped EVM(1) 104's brake 212 is activated to decelerate 310 the EVM(1) 104 to stop 312 at station(1) 103. When stop, auto opens the door 314 to switch passengers 107 off and on 316. When finished, auto-closing the door 317 and waiting for signal 306 to re-launch

This operation will result in a total time saving of 4.53 hours than without using this invention of 7.7 hours, 4.53/7.7=0.59, a holly 59% saved by the operation using this invention. Due to saved time, the fare charge can run even higher like 30-50% more. Actually, there are total 37 stations, with average 17 kms distance in between the stations on the Acela route, including 21 small stations by-passed by the Acela Express. If all those stops included and still run 3.17 hours, revenue could be more than doubled.

The other embodiment of the invention for the metro mass transit system to handle crowded passengers during the peak time is to make the HVM/MVM/EVM passenger compartment 401, 407 having a maximum clearance in height and width, so as to allow the internal structure accommodate a blocking-free-pass-through path 402 or 403 for the near-off passengers moving from head HVM 106 to the end EVM 104 through MVM 105, also allow the least interference between long distance passengers and near-off passengers. A specific use case is to make the free-pass-through path 402 located in the upper-middle section, or in the side-section 404. One particular embodiment could be a double deck module that make the stay-passengers go to the top 501, 502, 503 or bottom 504, 510, 511 modules and near-off passengers go to the lower 504, 510, 511 or upper 501,502, 503 modules, with option to make the upper or lower deck section relative fixed to the movable lower or upper section. Here illustrate a specific use case of a relative fixed top module 501, 502, 503 and a movable lower module 504, 510, 511 The idea is to allow the EVM 104 direction moving near-off passenger free of blocking and jamming during the crowded peak traffic time.

The above use case of making the upper section of each module relative fixed to the bottom section can make stay passengers going to the top through the stairs or lifts of 509 without bothering interfering with the bottom near-off backward moving passengers. Between the top section and lower section, there is a moving mechanism build into the bottom of top section 506 and the top of lower section 506, that are activated to move by signals for bottom HVM launching 306 to move ahead and bottom EVM 504 release-dropping 306 at the lower end, and by which, the bottom MVM 510 shall follow the leaving EVM 504 moving backward relatively to fill the empty lower section left over by the leaving lower EVM and give out the same module space in front of the MVM 510 which will hold the incoming lower HVM 511. This upper and lower modules shifting movement is conducted by the signal command instructing the electric-mechanical system 508, 514, 603, 605, 609 in the upper and lower section of the MVM 501, 502, 503 and 504, 510, 511 to 1) close and lock 713 the doors 512, 509 in between and on each side of the upper 501, 502, 503 and lower modules 504, 604, 510, 608, 511, 610, and through doors 612 close and lock in between and on each side of EVM 604 and MVM 608, and HVM 610 and MVM 608, 2) meeting the pair of rail guides 508, 514, 605 with teeth, affixed in the slot spaces at the top of the bottom MVM 504, 510, 511, with the pair of roller gears 609 located underneath of the seats 512 compartments 513 from upper MVM 501, 502, 503 that are lowering 706 and gearing in 707 with the rail guide 508, 514, 605, 3) a motor 603 drive the gear 508 and 609 to move 707 the lower 604, 608, 610 and upper 601 MVM and toward the opposite direction 611 and 602, 606, 607: the lower MVM 604, 608, 610 move backward 707 toward the empty lower EVM 604 position in the end, and the upper MVM 601 move forward 707 to give the same EVM 604 space underneath it in the front, and 4) upon the MVM 608 moving into 708 the former lower EVM 604 position, lock 710 with the upper MVM 601, and 5) gear off the rail guides 508, 514, 603 and roller-gears 605 and move 709 back to its original position, 6) in the mean time to have the incoming lower HVM 610 guided move into 708, the giving empty space under the MVM 601, and 7) lock up 710 with upper MVM 601 and 610 automatically at the lower HVM 610 filled position, 8) unlock and open 714 doors 512, 509 in between and on each side of upper 610 and lower 604, 608, 610 modules, through doors 612 in between and on each side of lower EVM 604 and MVM 608, and HVM 610 and MVM 608. 8) the 1)-8) steps shall repeat 711 at each passing-by station 103(n) in turn till to the end station 712 where there is no more HVM 610 in the front, so there is no EVM 604 releasing. Rail guid gears 508, 514, 605 coupled with a roller gears 609 to move the module top 601 and bottom 604, 608, 610 is only one choice of options of many existing electric-mechanical mechanisms that can do the work and are choices of this part of the invention components to use.

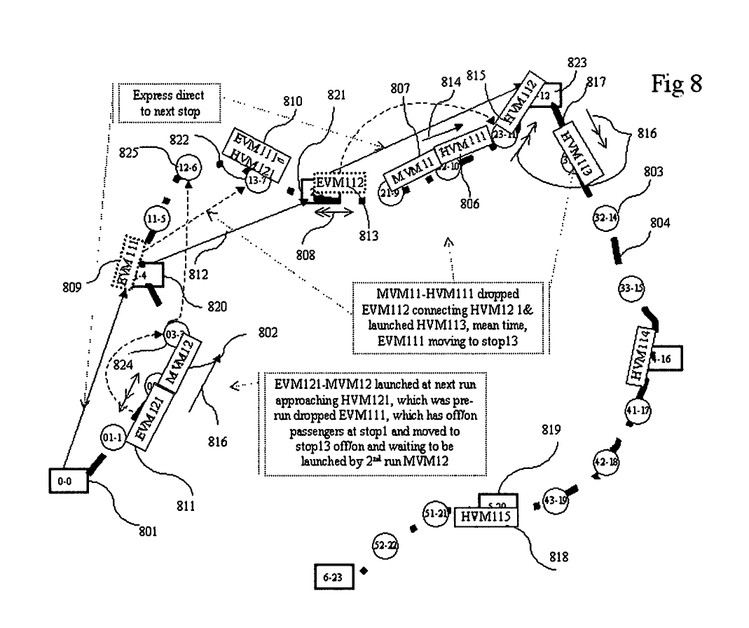

In one of the preferred embodiment of this invention, which is suited for the very condensed stop to stop distance situation in large urban mass transit environment, such as New York Subway, with an average between stop distance of only about 0.8 km or 0.5 miles, and the previously mentioned Beijing Subway situation, it is not suitable a direct use the above mentioned implementations for this invention, unless there is enough distance, such as >4 kms or 2.5 miles between stops for the most economic operation, this can be solved by skipped stops in between, which is another preferred embodiment of the invention's vehicle module operation system's special method to make it work perfectly to solve the problem, where the vehicle module operation system operating in at least one method of many, where the modules of HVM111-MVM11-EVM111 is operated nonstop for some skipped stops in between the EVM drop-stop, and HVM launch-ahead (at every station regularly) mode, such as every 2-6 stops skipped, and with rotating drop-stopped EVM(11n), where n is the number of non-skipped stops) self-driving to the next farthest skipped stop ahead before the next non-skipped stop, which is where the next HVM(n=i+1)'s one stop earlier the skipped station(n−s) [(n−s)=s−1, s is the station series number]. This one stop shifting one after another will allow rotating pick-up and drop-off passengers of all the skipped stations in turn by a serious scheduled new shift runs of HVM(kjn)−MVM(kj)−EVM(kjn), where, if n is the non-skipped stop station numbers, j is the shift numbers, and if maximal 3 skipped stops in between station(n−s) and station(n−(s+4)), HVM-MVM-EVM shall have j+1 time runs to cover the skipped stops between non-skipped stations, and then, start a new round of k+1, where k is circle number of a round, started by running a head modules series of 5 HVMs as it is at the very beginning, to drop each HVM211, to HVM215 for each Express non-skipped stations to pick up and drop off passengers, and that operate at a between run headway time intervals for new round of rotation shift runs. The method by FIG. 8 is:

1) the very first shift is a series of HVM111-HVM112-HVM113-HVM114-HVM115 of 806 to 818 if the stops head are 5, drop each one in turn one stop after another till stop 5-20 817, to pick up passengers.

2) After a time interval of s minutes, EMV111-MVM11 (at the end of MVM, it includes EVM111 to EVM115) 809, 807 start out from station (0-0) 801 with passengers, and center operation start to control by wired and/or wireless means including satellite position data to measure the distance De(n) and speed Ve of the modules and Drl(n), upon Drl(1)=De(1), release 306 the module EVM111 809 and launch 306 the HVM111 806 at station (1-4) 820.

3) By Ve, Drl, and obtain Ae and Be and start to instruct EVM111 809 decelerate 310 to stop 312 at station (104) 820 for passenger off/on 316, and accelerate 309 the HVM111 806 to meet the MVM11 807, and upon meeting, couple 311 the two together and open the through door 313 for passengers move through.

4) Continue step 2)-3) for HVM112 815 launching from station(2-8) 821 and EVM112 813 releasing and stopping at station(2-8) 821, and in the same time

5) EVM111 809 upon finishing passengers off/on and/or cargoes unloading/loading, move to the previously skipped station(13-7) 822 next to station(2-8) 821 and automatically becoming the HVM121 waiting signal to be launched by next shift EVM121-MVM12 811, 802, and in the mean time,

6) MVM11-HVM111 807, 806 running in Ve 814, meet/couple with HVM112 815, and and in the mean time, repeating step 2)-3) to launch HVM113 817 and drop/release EVM112 813 to stop at station(3-12) 823,

7) Upon a shift interval headway time s passed, new shift of EVM121-MVM12 811, 802 start running and after step 2)-3), start to launch HVM121 (previous EVM111) 810 at the station(13-7) 821, and in the same time drop/release EVM121 811 and decelerate to stop at station(03-3) 824,

8) Repeat step step 5)-6) for the 2^{nd} shift, where the EVM121 811 upon moving to the new station(12-6) 825 after finish passenger off/on and/or cargoes off-loading/unloading at station(03-3) 824, and continue to the next shift.

The interval headway is longer than previously non-express peak regular operation that has all station stopped, yet, has much more efficiency with more than double time saving, and have all the stops covered with express operation nonstop.

It is to be understood that the above preferred embodiment of the invention are only illustrated some of the key concepts and compositions of this invention, many variations and modifications can be made based on the accent of the above embodiment, which will be apparent to one skilled in the art, that are also within the spirit and scope of the invention as set forth in the claims below.

What is claimed:

1. an autonomous vehicle module and modules combination of grade 4 and/or 3 formation-deformation system adapted to various transportation modes, such as rail, maglev guideway, road lane, comprises:
a self-driving module and/or modules, having off-board central control and on-board sub-control means and methods that control such driving's launch, acceleration, move in constant velocity, steering in direction, deceleration and stop in accordance with a series of scheduled stops by the system's operating data tables along a defined route, and run through from start station to the end station nonstop at most economic operation velocity by past data pattern in the data table, while rotating in turn release modules and receiving modules from and to its moving master modules till to the end station;
a head vehicle module (HVM) and an end vehicle module (EVM), which (HVM and EVM module unit m>1 for each) are part of the master vehicle modules (MVM) in the middle (include 1 to N−m(HVM+EVM) units), rotating in turn release the EVM from MVM and launch HVM from station ahead on one of the moving transportation modes of medium-low speed vehicles on rail, maglev guideway, wheel on road, high speed train or maglev train or buts, etc.;
a central computer controlled network, wired and wireless connected with on-board and off-board control means along the operating route, having off-board and on-board electric-mechanical sensor and switch devices, station operation data table, vehicle module operation data table, switching track operation data table, double deck module-shifting operation data table to implement a scheduled multiple-stop nonstop operation method for passengers and cargoes in the EVM delivery on/off through a velocity control mean for the EVM stopping at each scheduled passing by station and HVM, MVM and EVM stopping at terminal end station. The method key steps:
a) receiving the control command for HVM launching and EVM releasing,
b) rotating in turn to launch and accelerate the HVM by its motors at controlled distance from each scheduled stop ahead of the moving MVM
c) couple and lock with the moving catching-on MVM at its speed in the front
d) At same controlled distance of launching HVM, by release command, drop and decelerate the EVM to a stop at each scheduled passing-by stop from the end of the MVM,
e) load and upload passengers and cargo upon EVM stopped
a near-off passenger path for moving backward to the EVM, located in the most optimized location that minimized the conflicting interference between the near-off passengers and stay-passengers, such as the upper-center or upper-side position in the module's internal space,
a divided double deck modules, having moving mean and mechanism build into the connecting section of the upper modules and lower modules for opposite direction shifting movement by the upper and lower modules and locking devices attached to the modules for affixing them together when they moved into the right move-in and left-over positions, which include at least a method:
a) upon signal of command instruction for HVM and EVM releasing and launching, close and lock the doors in between and on each side of the up/down path of the upper and lower modules, and the through doors in between and on each side of EVM and MVM, and HVM and MVM,
b) lower the motor driven roller-gears from the bottom of the upper modules inside the compartments beneath the passenger seats,
c) gearing in with the gearing teeth of the rail guides affixed on top of the lower modules and start to move in opposite direction for the top and bottom modules at the constant forward moving velocity and the roller gears' slow moving relative speed,
d) stop at the position at the end of the modules where upon lower EVM leaving out of upper MVM's lower part and lower MVM moved into the left-over EVM empty space, and lower HVM into the head of MVM's lower empty position,
e) lock the upper and lower modules
f) Unlock and open the doors in between and on each side of the upper and lower modules, and the through doors in between and on each side of the EVM and MVM, and the HVM and MVM
g) gear out and move the roller-gear back to its original position where the said above moving mechanism can be any conventional moving mechanism that can realize the above shifting in motion relative movement.
a controlled cargo movement for the cargo vehicle in the module by its delivery destination and corresponding station, includes control command, by bar-code, shipping data table of the cargo, mechanism for activation of the moving robot arm and hand, and a conventional process to move it off-loading from the cargo vehicle at the off-station.

2. the claim 1 said vehicle module include
a 1 to N member units of vehicles to form the module that includes power unit in the form of power source of choices of electricity from: overhead trolley pantograph collected electricity from network stations along the route, 3^{rd} and/or 4^{th} rails, solar panels or films or coatings on the surface of the vehicle modules and the surface of the graded or non-grated route right of way area, and micro-nuclear power generator, etc., and storage device that store the over capacity of power use generated and collected for its own and/or power-grid use; and
a cargo vehicle or compartment, having robot moving arm and hand controlled by operation center and on-board means for moving cargoes on and off;
a wireless and wired network and connected devices for receiving and sending data, where the said devices include small cells, Wi-Fi, etc. networks, that are installed on-board of the modules, on side of tracks' poles, inside tunnels of rail/guideway of trains, subway on the wall or fixtures inside, together with location and object sensors, radars to sensing, detecting, sending and receiving data,
an on-board control mean for processing data and issue instructions to control vehicle module speed, by commanding: 1) the on-board motor for acceleration of HVM in the front station, 2) the brake for EVM deceleration and stop, 3) coupling and decoupling device for connecting and disconnecting vehicle modules in the head and at the back, on the top and in the beneath, 4) locking and unlocking devices to lock and unlock vehicle modules, and 5) upper and lower vehicle modules opposite direction shifting-moving by electric-mechanical devices to new lower HVM and lower EVM positions and do corresponding unlocking, moving and locking of the upper and lower modules;
a single floor architect vehicle compartment include a near-off passenger backward moving path, located in the middle or side upper section of the compartment, which is provided to avoid the interference between the near-off passengers and stay-on passengers, requiring the vehicle module having maximum allowed space in height and width to accommodate the maximum allowed passengers in peak traffic times; or a double deck compartment, divided or as whole; in the case of double deck divide modules, it can include opposite moving mechanism located in between the bottom of the upper modules and top of the lower modules to move the upper modules forward and the lower modules backward during the forward movement of the whole combined upper and lower modules,
a bottom moving section to move the module forward, backward, change direction and stop, include electricity powered motors, controlled by the speed control devices, which power the wheels on the road or on the rail, or generate the electricity that power the electromagnetic driving and directing system in the case of maglev vehicle.
an air streamlined head and end outer-cover structure fold-able, extensible and withdraw-able to the top and/or sides of the module to reduce air resistance during the movement of the module in high speed when it rotating in turn to become the HVM or EVM.

3. Claim 1 and 2 said scheduled multiple-stop nonstop operation method for passengers and cargo delivery through a velocity control mean for HVM, MVM and EVM stop at each scheduled stop station, more detailed steps include:
a) The very first run of the vehicle modules operation in the morning, a HVM(n)(n=i+1, if i=0 at start station) with number of units of modules shall run through the route and drop-stop at each scheduled stop station, picking up first run passengers and cargoes.
b) vehicle modules leaving the start-terminal station, the central control operation control the movement of the vehicle modules MVM by constantly sensing its most economical operating speed (Ve) and the distance between the head of MVM and the station ahead using real time satellite positioning data from the moving MVM to determine the most economic distance De(n) from the front station scheduled for passengers on/off and/or cargoes loading/unloading,
c) At the distance when it is ideal to accelerate and decelerate at most economic rate for the time of Ta(acceleration time) and Td(deceleration time) for the HVM's end to meet the MVM's head, and for EVH releasing from the MVM's end, and here when condition change, Ve & Ta, Td change, which determine new Ve, that determine the ideal deceleration distance Dd for EVM and acceleration distance Da for HVM, together determine EVM releasing and HVM launching distance Drl(n) of station(n) ahead De(n)=(Dd+Da)/2. Assuming Drl(n) is the satellite position of the moving MVM to the station ahead and the De(n) is the ideal economic distance for launching HVM and releasing EVM, when Drl(n)−De(n)=0, meaning the ideal releasing EVM and launching HVM distance reached, the control center shall issue instruction to
d) authenticate the HVM at the front station and upon all operating data is verified ready for departure, including its ID, passenger/cargo boarding/uploading status by door lock status etc, in accordance with vehicle modules operating data table, station data operating table,
e) check the passenger/cargo on/off board and/or unloading/loading request for releasing the EVM for passenger and/or cargo off/on loading/unloading readiness,
f) set the acceleration and deceleration rate for the HVM and EVM by Ve, De(n) data,
g) upon readiness of HVM and EVM, instruct the on-board control mean to instruct its power-motor device to launch the HVM at the set acceleration rate to catch and meet the MVM at the end of it, and release the EVM by instructing the decoupling device to separate it from MVM and the brake to decelerate at set rate for the EVM to stop at the up coming station,
h) upon sensing the meet-touching of MVM and HVM by electric-mechanical sensor, couple the two together by an automatic connect-coupling and lock system, and release the through-door lock for passenger passing through, in the mean time the EVM upon sensing the entering of the station zone by electric-mechanical sensor, instruct brake to stop the EVM at stop line and/or track zone, which activate the EVM side door lock to open automatically for passenger off/on, cargo unloading/loading,
i) repeat b)-g) for the coming n stations until the end-terminal station reached, where there will be no HVM detected, and will be no releasing of the EVM, and
j) via a track/line switching procedure, the MVM will run continuously for a return shift, following the same operation process.
k) Passengers on board and at the station ahead push off button on vehicle modules and on button at the station to signal off and on request and display numbers of it at control center for capacity control.

3. Claim 1, 2 and 3 said divided double deck modules, having moving mean and mechanism build into the connecting section of the upper modules and lower modules for opposite direction shifting movement by the upper and lower modules and locking mechanism and devices attached to the modules for affixing them together when they moved into the right move-in position in the head and end of lower MVM, and the said moving mean are in one form, a pair of rail guides affixed on top of lower module inside a pair slots with space to allow the rail guides to gear in with the roller gears from either top or side or angled by moving to and gear in with the rail guides to do the shifting movement, and gear out upon finishing the job by moving away from the rail guides, and locking-stops at both end of the rail guides, where the move-shifting mechanism operates by a method, in one form as follow:
a) upon commands instructing for HVM launching and EVM releasing, close and lock the dividing doors between and on each side of the upper and lower modules, and the EVM and MVM, and HVM and MVM
b) move the roller-gear attached inside the compartment beneath the passenger seat of the top module down to gear-in with the rail guide affixed on top of the lower modules inside a slot space, and
c) motor drive the roller-gear to move the upper and lower modules relatively moving toward opposite direction for the distance of the module at the modules' moving velocity and gear-driven-motor's slow moving relative speed,
d) stop at end position by the gear-driven-motor and stop-lock upon the lower EVM leaving out of upper EVM of MVM's lower part and lower MVM moved into the left-over EVM space, and lower HVM into the head of MVM's HVM lower empty position,
e) lock the upper and lower modules and gear out by moving the roller-gear back to its original position
f) Unlock and open doors in between the upper and lower module, and the EVM and MVM, and HVM and MVM
said moving mechanism can be any moving-mechanism that can move the upper and lower module in opposite direction relatively in the whole modules forward moving velocity and stop the relative moving upon moving into the end move-in position.

5. Claim 1 and 3 said station operation data table, vehicle module operation data table, switching track operation data table, double deck module-shifting operation data table, include at least all the operation related data of all the components of the system that insure a successful operation of the vehicle modules, such as
a) the station table has the data set including at least the ID, stop-line-track switch, passenger/cargo boarding request, station satellite position, etc.,
b) vehicle module table data set includes at least, ID, satellite-position(x,y), economical (velocity, stop-time, acceleration-rate, Ta, deceleration-rate, Td), passenger-on-board info by ticket check-in, passenger off-request, HMV status (in turn when it is in the head of MVM, station, acceleration, deceleration, launch ready, coupling-position-couple/decouple & lock-position-lock/unlock, module-door-open-unlock/close-lock, etc.), EVM status (in turn when it is at end, same as the HVM), stop schedule (station behind, station by, station ahead), passenger alert (station(i), & station(i+1), on-board cargo item list by shipping code (shipping destination, due time, etc.), etc.,
c) cargo shipping table includes at least bar-code ID, shipping destination, due date, shipping status (cargo vehicle ID, location ID), etc.,
d) switching-track table data set includes at least satellite position, station track, change track switch by ID (route shifting to/from, location), position switch(on/off), etc.,
e) double deck module shifting table data set include at least, lower-module-shift-unlock/lock, motor-driven-gear on/off, etc.,
and other data set necessary for a smooth operation that is in conventional domain.

6. Claim 1, 2, 3, 4, 5 said vehicle module operation system operating in at least one method of many in the same nature, where the modules of HVM111-MVM11-EVM111 is operated nonstop for some skipped stops in between the EVM drop-stop, and HVM launch-ahead (at every station regularly) mode, such as every 2-6 stops skipped, and with rotating drop-stopped EVM(11n), where n is the number of non-skipped stops) self-driving to the next farthest skipped stop ahead before the next non-skipped stop, which is where the next HVM(n=i+1)'s one stop earlier station skipped, so the next shift HVM121-MVM12-EVM121 shall launch the HVM121=EVM111 at station(n=i+1)'s one stop earlier the skipped station(n−s) [(n−s)=s−1, s=0 to s, is the station series number]. This one stop shifting one after another will allow rotating pick-up and drop-off passengers of all the skipped stations in turn by a serious scheduled new shift runs of HVM(kjn)−MVM(kj)−EVM(kjn), where, if n is the non-skipped stop station numbers, j is the shift numbers, and if maximal 3 skipped stops in between station(n−s) and station[n−(s+4)], HVM-MVM-EVM shall have j+1 times runs to cover the skipped stops between non-skipped stations (n−s) and [n−(s+4)], and then, start a new round of k+1, where k is circle number of a round, started by running a head modules series of 5 HVMs as it is at the very beginning, to drop each HVM211, to HVM215 for each Express non-skipped stations to pick up and drop off passengers, and that operate at a between run headway time intervals for new round of rotation shift runs. The interval headway is longer than previously non-express peak regular operation that has all station stopped, yet, has much more efficiency with more than double time saving, and have all the stops covered with express operation nonstop.

7. Claim 1, 2, 3, 4, 5, 6 said HVM-MVM-EVM modules operation having number of emergency islands along the sides of the route and/or the stations to clear the way for straight run through of the vehicle modules, such as in situation of hazard or medical emergency, etc, where the stopped HVMs and EVMs will move to a side track or side parking place at the station to give the away for the HVM-MVM-EVM modules passing-through free of blocking. The said islands can also be in a wheel hanger structure with the rail or guideway or road passing-through the center of it, or undergo beneath it, while the HVMs and/or EVMs can be pre-loaded onto the wheel hangers and/or pallets, or when in emergency situation, could run onto its pallets and/or hangers to give the way out upon alert. This structure will save time and space for the HVMs and/or EVMs set up, specially good to use at the time of a station peak/off-peak time, when can add-on/move-away HVM and/or EVM to adjust transportation capacity,

8. Claim 1, 2, 3, 4, 5, 6, 7 said vehicle modules composed by HVM, EVM and MVM, where the said HVM in the station ahead, after launching and upon meeting the up coming MVM moving in constant speed, is becoming part of the MVM(HVM=MVM), and where upon leaving the MVM, the same HVM=MVM module is becoming EVM(HVM=MVM=EVM) for passengers and/or cargoes off loading and picking up, forming a rotating role change shifting chain by the changing function and purpose of the modules during a transport shift run; a module is composed of vehicle/car/rolling-stock and/or vehicles/cars/rolling-stocks, while the EVM and/or HVM and/or MVM are/is composed with autonomous module and/or modules.

9. Claim 2 said streamlined cover-head and/or end of the vehicle module in one of the structures can have a top structure that is affixed the the top of each end of the module and is auto-controlled by control center and on-board control means to activate the formation of it, upon the launch of the HVM from a station ahead of the MVM, when the front cover-head shall first forward extending out, and upon reaching the head's full extension position, simultaneously turning downward and extending outward to both sides by a multi-layer hinged-chained flexible light weight alloy sheets to cover the front in a smooth rounded curve and then lock into the end position that connecting the main module seamlessly. Upon the next HVM launching, the catching on head of MVM modules start to folding back its cover-head and withdrawal back to its original position to be ready for receiving and meeting the HVM ahead of it, the same action of activating a cover-head for the EVM upon its releasing from the MVM, and finishing the cover-head formation when it is stopped at the scheduled stop-station.

10. Claim 1, 2, 3, 4, 5, 6, 7, 8 and 9 said vehicle modules, operated in the rotating shifting of HVM to MVM to EVM with flexibility of adding and reducing modules in transit to reach an ever high capacity to handle the extreme of high traffic volume in mega metro mass transit situations in accordance with the on/off passengers and/or cargoes requesting data in real time, where the EVM can be a whole chain of 8-10 large cars combination, while the staying passengers on MVM is separated from the EVM, that leave a whole 8-10 cars empty train at the every station, which was impossible before when the 8-10 cars train was full of people heading to a city center destination, causing crowded packing of people in the car. This will handle at least double amount of traffic in peak time than the current most jammed station.
